(19) United States
(12) Patent Application Publication
(10) Pub. No.: US 2009/0102463 A1
(43) Pub. Date: Apr. 23, 2009

(54) Sensor Device and Method of Measuring a Position of an Object

(75) Inventor: Lutz May, Berg (DE)

Correspondence Address: FAY KAPLUN & MARCIN, LLP, 150 BROADWAY, SUITE 702, NEW YORK, NY, 10038, US

(73) Assignee: NCT ENGINEERING GMBH, Unterhaching (DE)

(21) Appl. No.: 12/280,905

(22) PCT Filed: May 14, 2007
(86) PCT No.: PCT/EP2007/004275

§ 371 Date: Oct. 31, 2008

Related U.S. Application Data
(60) Provisional application No. 60/803,376, filed on May 29, 2006.

(30) Foreign Application Priority Data
May 29, 2006 (EP) 06011003.8

(51) Int. Cl. G01B 7/00

(52) U.S. Cl. 324/207.16

(57) ABSTRACT

A sensor device for measuring a position of an object which is made of an inductivity influencing material. The sensor device includes a sensor unit and a processing logic arrangement. The sensor unit includes a magnetic field generator and a magnetic field detector. The magnetic field detector detects a magnetic field generated by the magnetic field generator. The processing logic arrangement processes signals from the magnetic field detector to determine the position of the object. The object is movable with respect to the magnetic field generator.

The invention relates to a sensor device.

The invention further relates to a method of measuring a position of an object.

Magnetic transducer technology finds application in the measurement of torque and position. It has been especially developed for the non-contacting measurement of torque in an object or any other part being subject to torque or linear motion. A rotating or reciprocating element can be provided with a magnetized region, i.e. a magnetic encoded region, and when the object is rotated or reciprocated, such a magnetic encoded region generates a characteristic signal in a magnetic field detector (like a magnetic coil) enabling to determine torque or position of the object. Such kind of sensors are disclosed, for instance, in WO 02/063262.

WO 05/064301 discloses another torque sensor based on a magnetic sensor principle and is based on the application of current pulses directly to an object, the pulses being defined by a steep raising edge and a slow falling edge.

U.S. Pat. No. 6,810,754 discloses a transducer for measuring displacement comprising a transducer assembly in which there is a coil wound about an axis and energizable to generate a magnetic field, and first and second magnetic field sensor devices, that are axially spaced with the coil therebetween, each device being in proximity to the coil to respond to a magnetic field component generated by energization of the coil. A ferromagnetic member is disposed to interact with the field generated by the coil, the ferromagnetic member and the transducer assembly being mounted for relative displacement in the direction of said axis, such that the balance of the respective field components sensed by the first and second sensor devices is a function of the axial position of the ferromagnetic member relative to the transducer assembly.

It would be desirable to provide an improved sensor device for measuring a position of an object and a method for measuring the position of an object.

The invention provides a method and device for measuring a position of an object, according to the subject matter of the independent claims. Further embodiments are incorporated in the dependent claims.

It should be noted that the following described exemplary embodiments of the invention apply also for the method, the device.

According to an exemplary embodiment of the invention there is provided a sensor device for measuring a position of an object, the sensor device comprising the object made of an inductivity influencing material; a sensor unit, the sensor unit comprising a magnetic field generator and a magnetic field detector, the magnetic field detector being adapted to detect a magnetic field generated by the magnetic field generator; and a processing logic being adapted to process signals from the magnetic field detector to determine the position of the object, wherein the object being movable with respect to the magnetic field generator.

Thus, the position of the object may be measured without the need to permanently magnetise the object or a part thereof.

According to an exemplary embodiment of the invention the sensor unit comprises a first coil forming the magnetic field generator as well as the magnetic field detector, wherein the processing logic is adapted to measure a power consumption of the first coil.

Thus, the changes in the impedance of a coils may serve as a base for a position detection. The sensor device may be calibrated by determining well defined positions and to store the results in a look up table. The sensor device may also be adapted to self calibrate during operation, when for example one sensor unit detects a minimum distance and the distance between two sensor units is known. The power consumption changes when changing the impedance of the coil. Narrowing an impedance influencing material to for example a coil will change its impedance and therefore its power consumption.

According to an exemplary embodiment of the invention the sensor unit comprises a first coil serving as the magnetic field generator as well as the magnetic field detector, the first coil being part of a oscillating circuit, wherein the processing logic is adapted to measure a frequency or amplitude of the oscillation circuit.

Thus, the frequency may serve as a parameter on the position of the object. The amplitude may also serve as an parameter when maintaining the resonance frequency. In other words the arrangement may serve as a oscillation circuit, the tuning thereof may serve as parameter on the position of the object.

According to an exemplary embodiment of the invention the sensor unit comprises a first coil serving as the magnetic field detector and a second coil serving as the magnetic field generator, wherein the processing logic is adapted to measure a power transmission from the first coil to the second coil.

Thus, the arrangement may work like a transformer or transducer. The quality of transmission from the first to the second coil or vice versa thus may serve as a base for determining the distance and position of the object.

According to an exemplary embodiment of the invention the sensor unit comprises at least two magnetic field detectors to form a compensated gain type.

Thus the sensitivity of the device may be increased by using a differential effect of the detectors. The use of two detectors may also provide information on the direction of movement of the object. It should be noted that also each of the two detectors may be of the gain compensation type.

According to an exemplary embodiment of the invention the sensor unit comprises at least three magnetic field detectors being arranged in a compensated gain type.

The provision of a third detector may give information not only on the direction, but also on some indifferent states being present in the two detector arrangement.

According to an exemplary embodiment of the invention the object is made of a ferromagnetic or ferrite material.

A ferromagnetic material may provide good properties with respect to the influencing of the inductivity. Ferrite material may provide good properties with respect to the influencing of the inductivity also at higher frequencies.

According to an exemplary embodiment of the invention the first coil is circumferentially arranged to a path the object is moving on.

Thus, the a rotation of the object around a centre axis of the circumferenced area may be eliminated. This may be of relevance if using a piston in a cylinder, if only non-centre portion of the piston is made of the inductivity influencing material.

According to an exemplary embodiment of the invention there is provided a piston cylinder arrangement comprising a cylinder; a piston, wherein the piston being movably arranged within the cylinder; at least one inventive sensor device, wherein the piston comprises at least a portion, which portion forms the object, and wherein the magnetic field detector is arranged on the cylinder.

According to an exemplary embodiment of the invention the piston cylinder arrangement comprises at least two sensor units, wherein the measurement ranges of the at least two sensor units abut or overlap to each other.

Thus, the position determination may be carried out on a longer distance and the detection and position of the object may be handed over from one to the neighboured sensor unit or sensor device.

According to an exemplary embodiment of the invention the cylinder is made of a non-ferromagnetic or non-ferrite material.

When providing the cylinder of a non-ferromagnetic material, the ferromagnetic properties of an object in form of a piston or part of a piston may be improved. However, the sensor device will also work with a cylinder of ferromagnetic material, since the magnetic properties of each ferromagnetic material provide a finite μᵣ so that also a further ferromagnetic material behind a ferromagnetic wall may detected. The success of the sensor depends on its sensitivity.

According to an exemplary embodiment of the invention, a sensor device for measuring a property of an object is provided, the sensor device comprising the object made of a (for instance permanently or temporarily) magnetizable material and having a portion with a varying geometrical shape along a longitudinal axis of the object, a magnetic field generator adapted to generate a magnetic field in the object (particularly to magnetize the portion made of a magnetizable material), and at least one magnetic field detector arranged in vicinity of the portion of the object with the varying geometrical shape to detect at least one detection signal in response to the magnetic field generated in the object, wherein the at least one detection signal is indicative of the property of the object.

According to another exemplary embodiment of the invention, a method of measuring a property of an object made of a (for instance permanently or temporarily) magnetizable material and having a portion with a varying geometrical shape along a longitudinal axis of the object is provided, the method comprising generating a magnetic field in the object (particularly magnetizing the portion made of a magnetizable material), and detecting, in vicinity of the portion with the varying geometrical shape, at least one detection signal in response to the magnetic field generated in the object, wherein the at least one detection signal is indicative of the property of the object.

According to yet another exemplary embodiment of the invention, a sensor device for measuring a property of an object is provided, the sensor device comprising the object made of a (for instance permanently) magnetized material and having a (for instance permanently) magnetized portion with a varying geometrical shape along a longitudinal axis of the object, and at least one magnetic field detector arranged in vicinity of the portion of the object with the varying geometrical shape to detect at least one detection signal in response to the magnetic field generated by the magnetized portion of the object, wherein the at least one detection signal is indicative of the property of the object.

According to still another exemplary embodiment of the invention, a method of measuring a property of an object made of a (for instance permanently) magnetized material and having a (for instance permanently) magnetized portion with a varying geometrical shape along a longitudinal axis of the object is provided, the method comprising detecting, in vicinity of the portion of the object with the varying geometrical shape, at least one detection signal in response to the magnetic field generated by the magnetized portion of the object, wherein the at least one detection signal is indicative of the property of the object.

According to an exemplary embodiment, a varying geometrical shape of a magnetic material along a longitudinal axis of an object may be used as a basis for deriving position information of the object. The longitudinal axis may indicate a main axis of the object, for instance a central axis of a cylindrical shaft. Usually, the extension of the object is larger in the longitudinal axis than in other axes perpendicular to the longitudinal axis. When the shape is non-homogeneous along the longitudinal axis, complete or partial magnetization of the object may generate a spatially dependent magnetic field pattern along the longitudinal axis of the object which may be detected by a magnetic field detector, like a coil. When the object moves or is shifted along the longitudinal axis, for instance when a screwdriver moves a screw with a thread as the portion with the varying geometrical shape along the longitudinal axis, position changes may result in a detection signal pattern which is a “fingerprint” of the varying geometrical shape. Therefore, such position related information or motion related information may be derived from this pattern.

The magnetizable portion and the remaining material of the object may be integrally formed, particularly may be made of a single (magnetic) material.

Conventionally, a magnet may be attached (for instance adhered) to an object of a screw-like arrangement. A Hall probe may be provided adjacent the object. When the screw is turned, the position of the adhered magnet with regard to the Hall probe is modified so that the signal detected by the Hall sensor changes as well. However, undesired cross-talk between such attached magnets and neighboured elements may occur since such a magnet attach system generates a magnetic field strength of 140 G and more.

In contrast to this, exemplary embodiments of the invention are based on the recognition that a geometrical inhomogeneity (for instance a periodicity like the groove-protrusion structure of a thread or the tooth structure of a saw-blade) can be used as an element to be magnetized so as to generate a spatially dependent magnetic field detectable by one, two or more detection coils. Therefore, a position dependent geometrical shape may be converted into a position dependent magnetic detection signal.

For instance, a cylindrical shaft may be treated by milling or the like so that surface portions of the object may be selectively removed. For instance, different shaft regions may be treated by milling so as to remove portions which vary along the longitudinal extension in an angularly offset manner. For example, cavities may be milled in the object, and when the object is turned and/or actually moved, such grooves pass sensing coils which detect the magnetic field when the magnetizable material has been magnetized beforehand. Thus, some kind of transformator principle may be used to detect the position, wherein the object may act as some kind of yoke.

For example, a 100 kHz current signal may be applied to a magnetic field generator coil to magnetize the object with the varying geometrical shape in a time-dependent manner. More generally, a time-dependent electric signal, for instance an AC signal (or alternatively a DC signal) may be applied to the object to magnetize the object. The object should have a magnetic property, for instance should be made from a paramagnetic material. This may be preferred over using a ferromagnetic material for the object (which is, however, possible as well), since a paramagnet has the advantage that the magnetization vanishes essentially after having switched off the exciting magnetic field so that, after the measurement, the object does not have a significant magnetic remanence which may disturb measurements and neighboured magnetic-field sensitive elements.

When using a drill as the object, or any other element in which the varying geometrical shape has some kind of helical or spiral external geometry, it may be advantageous to provide two detection coils for measuring the detection signals simultaneously, and to arrange the detection coils not at opposite sides of the object but, for instance, with a 90° offset in a circumferential direction of the drill, since the helical shape of the protrusions then generate magnetic detection signals which have a phase shift with respect to one another and may therefore provide particular meaningful results.

For generating the magnetic field, a current may be applied to a generator coil which then generates the magnetic field (which may be adjusted by the number of windings of the generator coil). Due to the grooves of the drill in the vicinity of the detection coils, the detection signal may be modified/modulated characteristically when the object is longitudinally moved or turned since this has an influence on the distance between the magnetized drill and the detection coils and consequently on the detection signal.

For instance, two coils may be asymmetrically arranged and supplied with a detection signal at each point of time so as to generate a non-symmetric stray field indicative of the position related information of the object.

One exemplary aspect is therefore that an electric signal, for instance an AC signal, is applied to a generator coil and that an asymmetric feedback geometry between two detection coils may be used to derive position information.

By using essentially remanence-free material for the object which however has magnetic or magnetizable properties, a high precision position sensor may be provided which has essentially no negative impact on surrounding magnetic field sensitive components in the absence of a measurement.

The generator coil can surround the object so that the object can be positioned in an inner opening of the generator coil. However, it is also possible to position the generator coil adjacent the object.

Sensors using elements having a spatially dependent geometrical property along a longitudinal axis is that a cheap, distortion-free, maintenance-free and highly integrated sensor with a small geometrical extension may be provided, which allows to manufacture high performance position sensors. It is possible to work with analog signals. Low cost and non-contact angular and longitudinal position detection may therefore be made possible.

According to an exemplary embodiment of the invention, a non-symmetry of the geometry of the material of the component itself may be used, and this material property is “activated” by providing an external excitation field using the generator coil. For instance, a periodicity in the geometry (for instance a spiral shape geometry) may be used.

For instance, geometrically inhomogeneous structures like drills having spirally wound protrusions, screws (having a spirally shaped protrusion in a thread) or saw-blades (having a plurality of saw teeth as a spatially varying geometrical structure) may be used. For example, a conventional drill or a conventional screw may be used as they are for manufacturing a sensor device. A saw tooth blade may, for instance, be inserted into a longitudinal recess of a for instance cylindrical structure in which the recess with a geometry corresponding to the saw-blade may be formed. In such a scenario, the object itself may be magnetic or non-magnetic, and this cylinder with the inserted saw-blade does not only provide a magnetic inhomogeneity along the longitudinal axis due to the teeth, but also in a circumferential direction since the strip-like saw-blade inserted into a slit in the object may also provide for a circumferential modulation of the magnetic field. It is possible to insert one or a plurality of saw tooth in one or more recesses of such an object.

According to one exemplary embodiment, the object is made of a magnetizable material which is activated upon applying an electrical signal to the generator coil. However, according to another exemplary embodiment, a sensor device is provided which is already magnetized so that a generator coil may be dispensable. The magnetization of such a material may be performed by various manners known as such, which are also disclosed in WO 05/064301. This may include applying a current pulse directly to the object, the pulse being defined by a steep raising edge and a slow falling edge. It is also possible to place a magnetizing coil around the element to be magnetized and to apply a direct current or a pulse for magnetization. Furthermore, it is possible to magnetize an element by approaching a magnet (for instance a ferromagnet or an electromagnet) to the element to be magnetized and move this element along the object with a sufficiently small distance between. By taking this measure, the magnetizable material of the object will be magnetized. However, many possibilities exist how to magnetize such a sensor.

According to exemplary embodiments of the invention, a signal intensity of less than 30 G may be made possible (for instance in the order of magnitude of 6 G). Therefore, in contrast to conventional approaches, the necessary amplitude of a signal may be significantly reduced since a geometrical pattern may be used as a fingerprint for a magnetic detection principle.

In the following, further exemplary embodiments of the invention will be explained. Next, further exemplary embodiments of the sensor device will be explained. However, these embodiments also apply for the method of measuring a property of an object.

The object may comprise grooves along the longitudinal axis. Such a groove-protrusion structure which varies along the extension of the object may, when the protrusion material is magnetic or is magnetized, result in a position dependent magnetic field detection pattern.

The grooves may be of a helical shape, a spiral shape, a saw tooth shape, and a thread shape along the longitudinal axis. However, any kinds of groove-protrusion structures are possible which may modulate a detection signal.

The object may comprise a plurality of teeth along the longitudinal axis. Such a tooth structure may be obtained, for instance, with a saw-blade structure, a comb or the like.

The object may comprise a plurality of recesses along the longitudinal axis, wherein the plurality of recesses are formed at different positions along a circumference of the object. Such recesses which when being removed by milling or another material removal method, a spatial dependence of a magnetic signal may be made possible.

The object may comprise a plurality of protrusions along the longitudinal axis. Therefore, not only the removal of material and therefore modification of the geometric structure along the longitudinal axis is possible, but also the addition of material resulting in such protrusions. Also such protrusions of a magnetizable material may alter the magnetic field detection signal in a manner so as to derive position information from the signal.

The object may comprise a carrier element having a longitudinal slit and may comprise a saw-blade inserted into the slit. Such a carrier element may, for instance, have the structure of a pencil or the like, that is to say may be a non-magnetic material in which one or a plurality of slits are formed circumferentially and/or longitudinally, and the magnetic or magnetizable material may be inserted in such slit or slits. Therefore, any desired magnetic field structure may be designed.

The carrier element may be a non-magnetic material (for instance may be made of a plastic, a wood, or a non-magnetic metal), and the saw-blade may be made of a magnetizable or magnetized material (for instance from iron, nickel or cobalt).

The portion with the varying geometrical shape may have a periodic geometrical shape. Such a periodic geometrical shape which is repeated a plurality of times along the longitudinal axis may result in a periodic modification of the field pattern along the longitudinal axis.

The object may be essentially cylindrical. For instance, the object may be a shaft of an engine or a pin/rod of a turning button, or may be a shaft of a reciprocating push-pull rod in a gear box. However, any other applications are possible in which position or motion related parameters of the object shall be measured.

It is possible to arrange two magnetic field detectors around the cylindrical shaft and to arrange the two magnetic field detectors with respect to one another with an angular offset differing from 180°, particularly with an angular offset of essentially 90°. In a spiral-like magnetic field pattern, an angular offset of 90° may be advantageous since this may allow to measure meaningful and complementary information with the two sensor coils, in contrast to a configuration in which the angle is 180°.

The sensor device may comprise a supply unit adapted to supply a direct current or a direct voltage or an alternating current or an alternating voltage to the magnetic field generator to generate the magnetic field in the object. Such a supply unit may be a power supply unit which may be controlled by a central control unit (CPU) to coordinate the application of the field exciting signal and the operation of the sensor device. However, the supply unit may not only apply a DC, but it is also possible to work with AC signals.

A direct electric signal or an alternating electric signal may be applicable to the magnetic field generator to generate the magnetic field in the object with an amplitude of less or equal 30 Gauss. By using such small magnetic fields, any undesired cross-talk to surrounding components may be securely prevented.

The sensor device may further comprise a determination unit adapted to determine at least one parameter indicative of the one or more properties of the object or shaft (for instance of an external influence exerted on the movable object) based on the at least one detection signal. Such a determination unit may be a microprocessor or a computer.

The magnetic field generator may be a magnetic field generator coil. For such a magnetic field generator coil, the number of windings and/or the length and/or the cross-sectional area may be chosen (for instance optimized) to achieve accordance with required or predefined specifications. The coil axis may be configured or designed in such a manner that the object may be located inside thereof. In other words, the windings of the magnetic field generator coil may surround the movable object. However, it is also possible that the object is located outside of the coil, for instance positioned laterally thereof.

The sensor device may comprise two magnetic field detectors which may be arranged symmetrically (with respect to and/or) on the magnetic field generator. In such a configuration, the signals of the two magnetic field detectors may be analyzed or evaluated simultaneously, and disturbing effects and artefacts (like the earth magnetic field or magnetic stray fields) may be eliminated by means of a mathematical analysis (for instance by calculating a difference signal, a weighted signal or an average signal).

The sensor device may comprise a plurality of magnetic field detectors. For example, it is possible to use 2, 3, 4, 5, 6 or even more magnetic field detectors to improve the accuracy. For instance, the plurality of magnetic field detectors may each detect a signal, so as to carry out an at least partially redundant measurement.

At least one magnetic field detector may comprise a coil having a coil axis oriented essentially parallel to the longitudinal axis of the object. However, it is possible that the coil has a coil axis which is oriented essentially perpendicular to the longitudinal axis of the object. A coil being oriented with any other angle between coil axis and extension of the object is possible as well. As an alternative to a coil in which a moving magnetized region may generate a motion-dependent or position-dependent electrical detection signal, a Hall-effect probe may be used as a magnetic field detector making use of a Hall-effect. Alternatively, a Giant Magnetic Resonance magnetic field sensor or a Magnetic Resonance magnetic field sensor may be used as magnetic field detector. However, any other magnetic field detector may be used to detect (qualitatively or quantitatively) the presence or absence and/or the strength of a magnetic field which magnetic field may be modified by any external influence exerted on the moving object.

The property of the object to be determined may be selected from the group consisting of an angular position of the object when being rotated and/or shifted along the longitudinal axis, a longitudinal position of the object when being rotated and/or shifted along the longitudinal axis, a torque applied to the object, a force applied to the object, a shear force applied to the object, a velocity of the object, and an acceleration of the object, or a power of the object. However, according to exemplary embodiments, a longitudinal or angular position of the object relative to the detector(s) may be detected which may of particular interest. In this context, benefit may be made of the asymmetric geometrical configuration of the object along the longitudinal extension. However, the given examples are not the only possible parameters to be sensed according to exemplary embodiments of the invention. Furthermore, it is possible to measure a plurality of the above or other parameters simultaneously or subsequently. Measured parameters can also be further processed, for instance to derive other parameters.

The sensor device may comprise a plurality of magnetic field generators. Thus, the accuracy of the measurement may be refined using additional generator coils. Particularly, the plurality of magnetic field generators may be arranged along an extension of the object (which may be a movable object). When a magnetic field detector is realized as magnetic field generator coils, the coil axis of the magnetic field generator coils may be oriented parallel with respect to one another.

The sensor device may be adapted for measuring a position-related property of the object. Since the geometry of the magnetic or magnetizable material varies along the object, this geometrical pattern can be used to derive a position which is correlated with this pattern. Therefore, magnetic patterns may be translated into position information, according to exemplary embodiments of the invention.

The object may be made of one of the group consisting of a paramagnetic material and a permanent magnetic material. Using a magnetic material which has no significant remanence after switching off an exciting magnetic field, cross-talk to other components due to a remanence field may be prevented. However, using a permanent magnetic material may make the generator coil dispensable.

The object may be a drill, a screw, a saw-blade, a tube, a disk, a ring, and a none-round object. In principle, the object may be of any shape as long as the shape of the object is varied along a longitudinal extension of the object so as to allow a spatially dependent measurement.

The aspects defined above and further aspects of the invention are apparent from the examples of embodiment to be described hereinafter and are explained with reference to these examples of embodiment.

It should be noted that the above features may also be combined. The combination of the above features may also lead to synergetic effects, even if not explicitly described in detail.

The invention will be described in more detail hereinafter with reference to examples of embodiment but to which the invention is not limited.

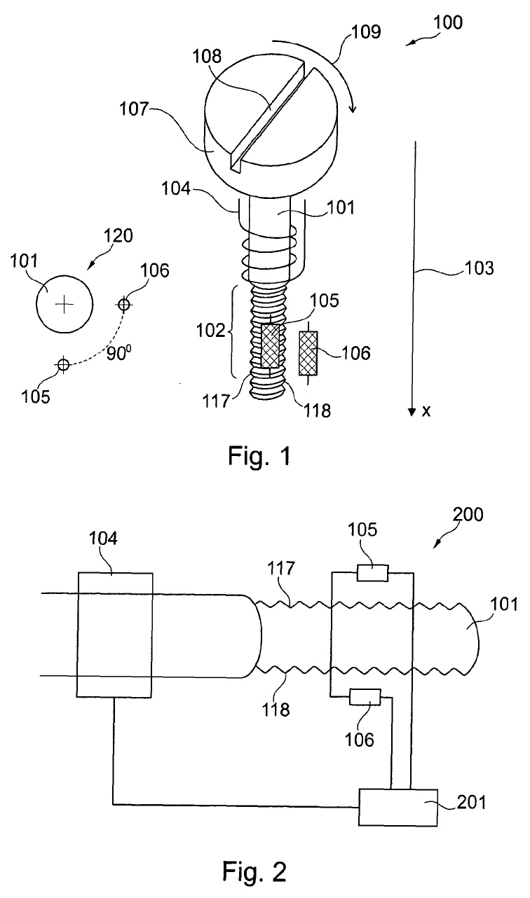

FIGS. 1 to 8, 10 to 12, 14, and 15 illustrate sensor devices according to exemplary embodiments of the invention.

FIG. 9 illustrates a method of magnetizing a magnetizable component of a sensor device according to an exemplary embodiment of the invention.

FIG. 13 illustrates schematically sensor signals detected by the coils in FIG. 12.

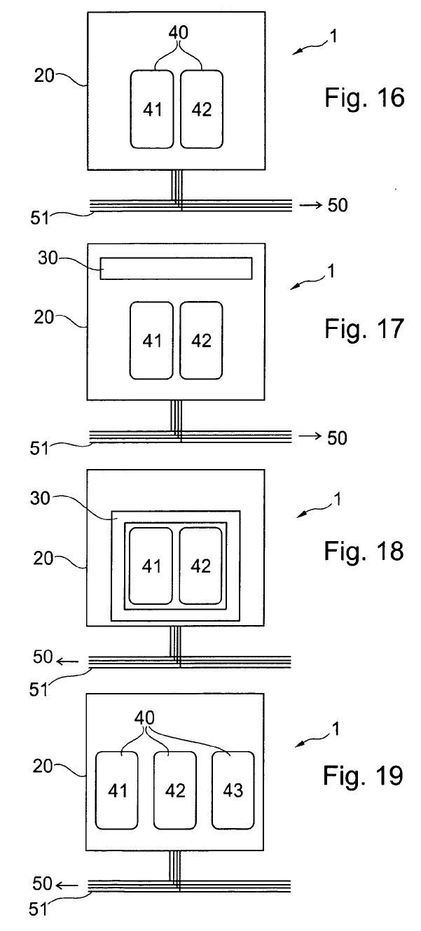

FIGS. 16 to 19 illustrate different arrangements of the magnetic field generator and detector elements.

FIGS. 21 to 23 illustrate different principles for determining parameters from a coil having a changed inductivity.

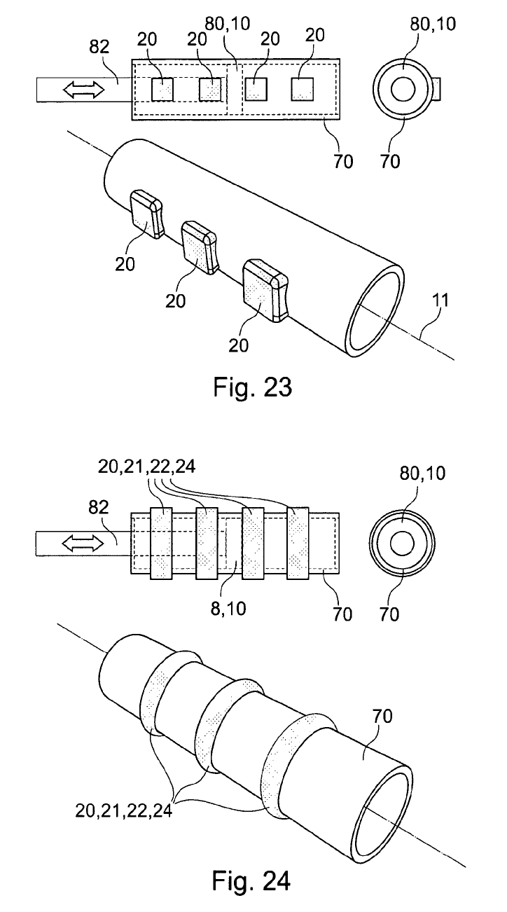

FIGS. 23 and 24 illustrate different geometries of the sensor units or the coils on a cylinder.

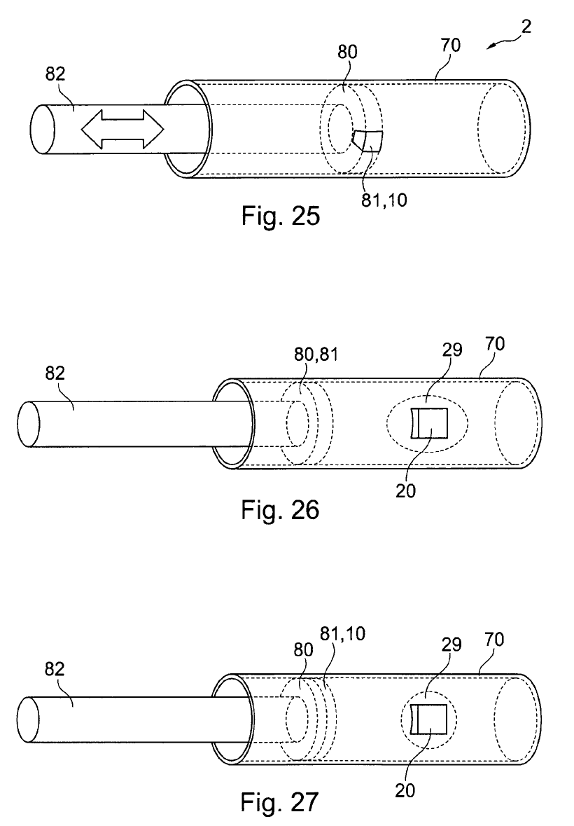

FIGS. 25 to 27 illustrate further embodiments of the invention.

The illustration in the drawing is schematically. In different drawings, similar or identical elements are provided with the same reference signs.

In the following, referring to FIG. 1, a sensor device 100 according to an exemplary embodiment of the invention will be explained.

The sensor device 100 is adapted for measuring a property of an object 101 made of a magnetizable steel and having a threaded portion 102 with a varying geometrical shape along a longitudinal axis 103 of the object 101. A magnetic field generator coil 104 is provided, and the object 101 is positioned in an interior of the magnetic field generator coil 104. By applying an electric signal to the magnetic field generator coil 104, a magnetic field may be generated in the object 101 so as to magnetize the magnetizable object 101 as long as the magnetic field generated by the coil 104 is maintained.

Furthermore, a first detector coil 105 and a second detector coil 106 are provided, with an angular offset of 90° in a circumferential direction, in a vicinity of the threaded portion 102. The two magnetic field detectors 105, 106 are thus arranged in vicinity of the threaded portion 102 of the object 101 with the varying geometrical shape to detect detection signals in response to the magnetic field generated in the object 101 by the coil 104, wherein the detection signals are indicative of the longitudinal position of the object 101.

As can be taken from FIG. 1, the sensor device 100 has a screw head 107 with a slit 108 to be engaged by a screwdriver (not shown). When the screw-like arrangement 100 is then turned in a turning direction 109, the longitudinal position of the object 101 is modified which results in a detection signal pattern detected by the coils 105, 106 which is indicative of the longitudinal extension.

The threaded portion 102 comprises a spiral groove 117 and a spiral protrusion 118 forming the thread. Thus, some kind of helical shape may be provided by the varying geometrical shape along the longitudinal direction 103.

Therefore, the threaded portion 102 has an essentially periodic geometrical shape, and the object 101 is cylindrical. The two magnetic field detectors 105, 106 are arranged close to the cylindrical shaft 101 and are arranged with respect to one another with an angular offset of 90°. This can be seen in a cross-sectional view 120 of FIG. 1.

As can be taken from FIG. 1, axes of the coils 105, 106 are oriented essentially parallel to the longitudinal axis 103 of the object 101.

Therefore, with the arrangement of FIG. 1, a longitudinal position/angular position of the object 101 may be determined.

In the following, referring to FIG. 2, a sensor device 200 according to an exemplary embodiment of the invention will be explained.

In FIG. 2, a signal conditioning and signal processing unit (SCSP) 201 (for instance a CPU) is provided for electronic purposes. On the one hand, the unit 201 acts as a determination unit for determining the position of the object 101 based on the detection signals provided by the coils 105, 106. Furthermore, the unit 201 also serves as a supply unit for supplying a DC or AC signal for activating the generator coil 104.

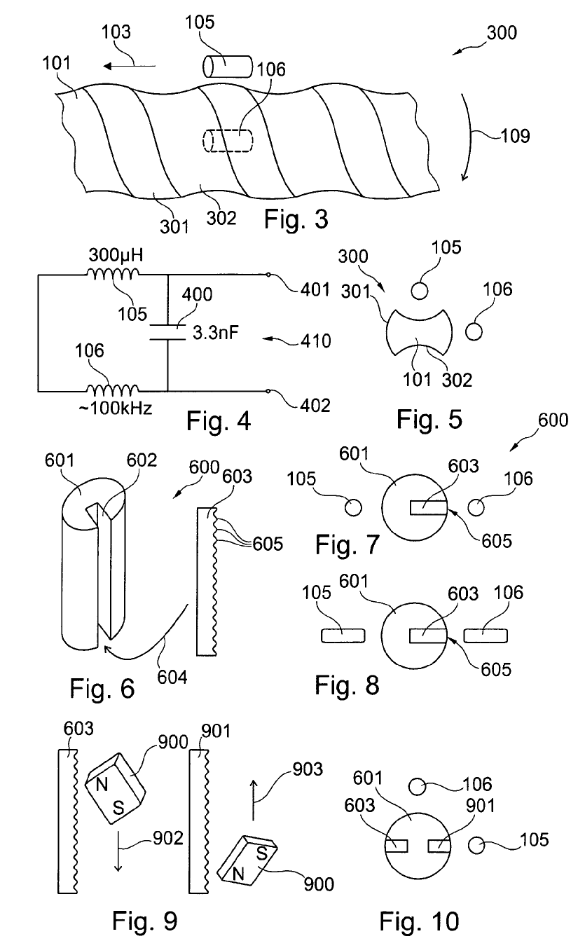

FIG. 3 shows an enlarged portion of a sensor device 300 which comprises an object 101 having a spiral shaped drill configuration along a longitudinal axis 103. Therefore, the drill shaft 101 comprises protrusions 301 and grooves 302. When the object 101 is turned as indicated by reference numeral 109, the grooves 302 and the protrusions 301 pass the coils 105, 106 so that a spatially dependent magnetic detection pattern is detected by the coils 105, 106.

FIG. 4 shows a circuit indicative of the coils 105, 106 and an auxiliary capacitor 400 in an oscillator configuration, wherein signals may be provided between terminals 401 and 402. Thus, the circuit 410 shows how the coils 105, 106 may be connected.

FIG. 5 shows a cross-sectional view of the object 300 showing a 90° offset between the coils 105, 106 with regard to a circumference of the drill shaft 101.

Namely, at each point of time, the signals generated in the coils 105 and 106 have an offset with respect to one another since a groove 302 may face one of the coils 105, 106 and at the same time a protrusion 301 faces the respective other one of the coils 105, 106.

Alternatively, a geometry of the coils 105 and 106 differing from the 90° arrangement in FIG. 5 is possible. For instance, a 180° geometry is possible when grooves and protrusions are arranged with an 180° offset to one another. An appropriate geometry can be adjusted by altering the angle of inclination of grooves and protrusions.

FIG. 6 shows a configuration of providing a sensor device 600 according to another exemplary embodiment of the invention.

The sensor device 600 comprises an object formed of a non-magnetic carrier element 601 in the form of a cylinder having a longitudinal slit 602 and a saw-blade 603 to be inserted into the slit 602, as indicated with reference numeral 604. As can be taken from FIG. 6, the saw-blade 603 comprises a plurality of teeth 605 which may be aligned, when the saw-blade 603 is inserted into the slit 602, along a surface portion of the resulting sensor device 600.

FIG. 7 shows a first configuration of sensor coils 105, 106 with respect to the sensor 600.

In the configuration of FIG. 7, the axes of the coils 105, 106 are essentially parallel to the longitudinal axis of the sensor object 601 which is perpendicular to the paper plane of FIG. 7.

In contrast to this, according to FIG. 8, the axes of the coils 105, 106 are in the paper plane of FIG. 8, whereas the longitudinal direction of the sensor object 601 is perpendicular to the paper plane of FIG. 8.

FIG. 9 shows an exemplary method of magnetizing a saw-blade 603.

In one configuration of the invention, such a magnetization is not necessary, for instance when the sensor device 600 is used in conjunction with a generator coil 104 to magnetically activate the saw-blade 603 selectively during the measurement. However, alternatively, it is possible to permanently magnetize the saw-blade 603 made of a magnetizable material by moving a permanent magnet 900 along a longitudinal extension of the blade 603. This is shown in FIG. 9.

Alternatively, other geometries are possible. Instead of a saw tooth, a twisted, tilted or wound wire may be used or any other geometrical structure having an asymmetric shape and being magnetisable.

As an alternative to the magnetization with the permanent magnet 900, it is possible to use an electromagnet or to conduct a direct or pulsed current through the permanent magnet 900 or any other magnetisable material. Also, it is possible to magnetize such a structure as disclosed in WO 05/064301 based on the application of current pulses directly to the structure, the pulses being defined by a steep raising edge and a slow falling edge.

Furthermore, in a configuration shown in FIG. 10, where two blades 603, 901 are used, the magnetization scheme may be as shown in FIG. 9, so that the magnetizing motion directions may be different, as indicated by arrows 902, 903.

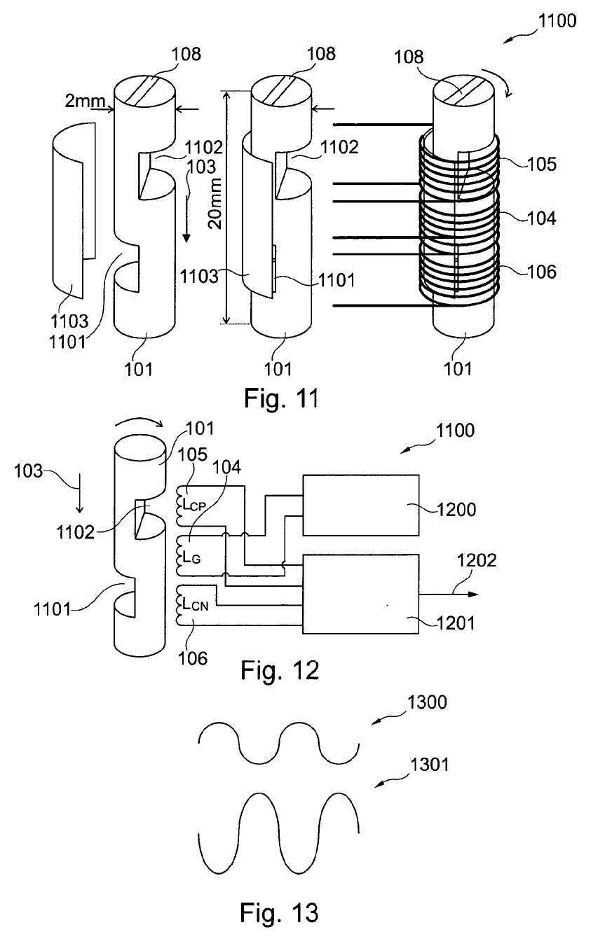

In the following, referring to FIG. 11, a sensor device 1100 according to another exemplary embodiment of the invention will be explained.

Again, an object 101 of a magnetizable material is provided. Along a longitudinal extension 103 of the object, circumferentially offset recesses 1101, 1102 are formed. As can be taken from FIG. 11, such recesses 1101, 1102 may be formed by removing material from a circumferential surface portion of the object 101, for instance by milling. A protection cover 1103 (for mechanically protecting and/or magnetically shielding) may be optionally put onto a surface portion of the object 101.

As can be taken from FIG. 11, an extension of the object 101 in the longitudinal direction may be 20 mm, whereas a diameter of the screw-like arrangement 1100 may be 2 mm.

As can further be taken from FIG. 11, a generator coil 104 may be located at a central portion of the object 101 in which no recesses are formed, and two detector coils 105, 106 may be provided in a vicinity of one of the recesses 1102, 1101, respectively.

FIG. 12 shows the electrical environment of the sensor device 1100 in more detail.

The generator coil 104 is connected to an oscillator circuit 1200 which supplies an alternating electric signal (AC) to power the generator coil 104 LG. Signals detected by the detection coils 105, L_{CP} and 106, L_{CN} may be evaluated using a differential signal operator unit 1201, and may then be provided for post-processing 1202. When the position of the object 101 changes in the longitudinal direction 103, a position-dependent field signal may be detected by the coils 105, 106.

However, when the object 101 is turned, an oscillating magnetic field may be detected by the coils 105, 106 as indicated with a first signal 1300 and a second signal 1301 in FIG. 13.

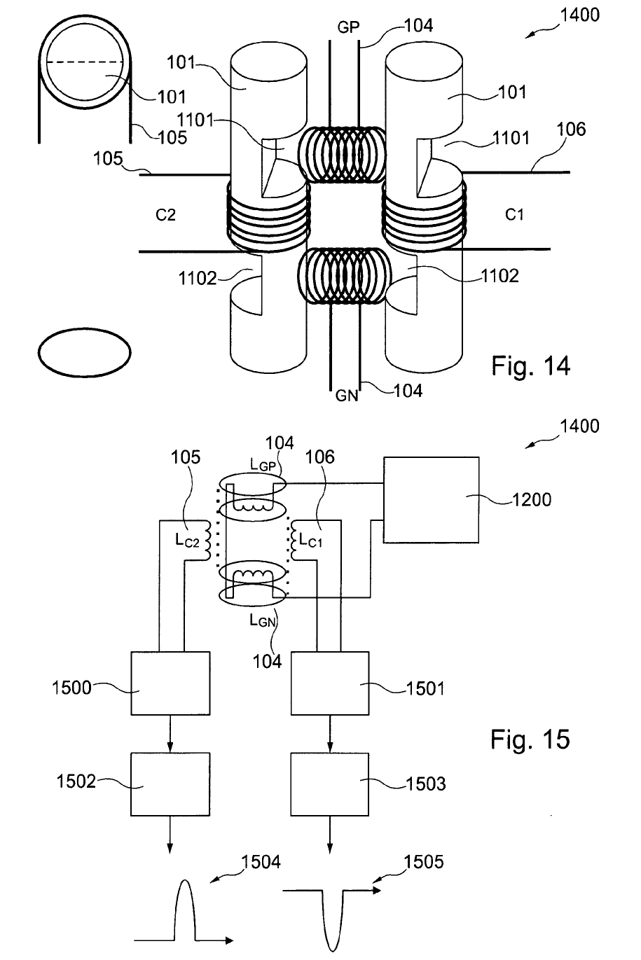

FIG. 14 shows a sensor device 1400 according to another exemplary embodiment of the invention.

According to FIG. 14, two shafts 101, 101 are provided in vicinity one another and they may be activated by two generator coils 104, 104. Furthermore, detector coils 105, 106 may be provided for detecting a magnetic field which is indicative of the angular and/or longitudinal extension of the objects 101.

FIG. 15 shows that an oscillator circuit 1200 powers the generator coils 104. A detection signal of the first detection coil 105 is passed through a first filter 1500 and a first decoder 1502 so that the signal 1504 (schematically shown) may be derived.

In a similar manner, a signal detected by the second detection coil 106 may pass through a second filter 1501 and a second decoder 1503 so as to generate a signal 1505 (schematically shown in FIG. 15).

Since the magnetic fields generated by the configuration of FIG. 15 are relatively small, undesired cross-talk between neighboured sensors may be efficiently suppressed.

The sensor arrangement may also be used for of any kind of piston-cylinder arrangements. Such arrangements may be used for water pumps or even for pumps, being operated in a dirty environment, like concrete pumps.

The inventive sensor device may serve as a Non-Contact, absolute measuring sensor, which is insensitive to mechanical shocks and vibrations. The sensor has a wide operating temperature range and can be applied at already existing cylinders/pistons. The measurement range is unlimited expandable (cascading) and the measurement resolution is better than 1% of FS (optional <0.1% of FS). A single supply voltage is enough and the sensor has a low current consumption, and a 0 to +5V output signal, and/or digital/serial digital output formats.

The here proposed sensing technology relies in some embodiments on the presence of ferromagnetic objects. It may be of importance that the materials used for building the piston and the hydraulic cylinder are analysed for their suitability of this specific sensing technology. Under certain circumstances it may be necessary that the some of the materials used may need to be exchanged to those that provide.

FIG. 25 illustrates a cylinder 70 having a piston 70 moving along a longitudinal axis of the cylinder. A portion 81 of the piston 80 may serve as an object 10, which position is to be determined. A piston rod 82 may connect the piston, e.g. a hydraulic piston, with a pump.

The sensor 20 may be provided on the outer surface of the cylinder and has a measurement range 29 depending on the material of the cylinder 70. The range 29 is for example larger for a cylinder made of a non-ferromagnetic material, as can be seen in FIG. 26. If the cylinder is of ferromagnetic material, the measurement range is smaller, as can be seen in FIG. 27.

Providing the sensors on the cylinder 70 instead of the piston rod 82 may reduce the risk that the magnetically processed piston beam will come in direct contact with a permanent synthetic magnet. In such a case the magnetic signature in the moving piston beam could be damaged which will affect the position sensor performance. The here proposed sensor principles may be used because of their reduced/or none sensitivity to external interfering magnetic field sources.

When applying a measurement concept (of detecting the piston position) that can operate from the outside of the hydraulic fluid pressured cylinder, then there are two sensor design options available to choose from. In one option described here, with respect to FIG. 23, a small position sensor unit 20 is attached at the outside of the cylinder 70. FIG. 23 illustrates a cross sectional view, a longitudinal sectional view and a perspective view thereof.

The position measurement range 29 of one individual sensor unit is depended on several factors, like the material used for the outer cylinder wall, and the thickness of the outer cylinder wall.

Assuming that the outer cylinder wall is made from non-ferromagnetic material, the position measurement range 29 of an individual sensor unit is much wider than when the cylinder wall is made from ferromagnetic material, as can be seen from FIGS. 27 and 28.

To cover the desired total linear measurement range of the piston movement it is therefore necessary to place side-by-side a number of individual position sensor units, the distance thereof depends on the material of the cylinder wall.

The physical dimension of the sensor units is directly related to the cylinder wall material, the cylinder wall thickness, and the material used for the object that is observed: the piston head.

The differential-inductive sensing technology will be applicable only when the piston head 80, 81 has suitable magnetic properties. In case the piston head is not magnetically detectable then the only remaining options for measuring the piston heads position are to tune the differential inductivity sensing technology so that it is able to detect the ferromagnetic piston rod or beam 82. Further, it is possible to place a magnet/magnetised object 81, 10 at the piston head.

The individual sensor units 20 may be connected to a main SCSP (signal conditioning and signal processing electronics or logic 50, trough an analog/digital bus 51. Based on the application specific requirements the sensor units can be connected in a daisy-chain or in a star arrangement.

Inside an individual differential inductive sensor unit are at least two independent working sensor systems 41, 42 that have the task to detect the movement of ferromagnetic objects 10 in one or more axes 11. The individual sensor units can be built very robust so that they will withstand the environmental operating conditions of a specific application. The individual differential inductive position sensor units may be attached to the outside of a cylinder 70 to detect the movements of a ferromagnetic object 10 at the inside of the cylinder 70.

According to another option, illustrated in FIG. 24, if the signal quality of the first option sensor design (FIG. 23) is insufficient to measure accurately the piston head position (inside the cylinder), a tangential sensor unit design is applicable, as can be seen in FIG. 24. The sensor unit design is such that it is wrapping itself around the outer cylinder 70.

This option of FIG. 24 provides a differential inductive absolute linear position sensor system. Like in the first option of FIG. 23, the individual sensor units 20 are placed side-by-side to cover the targeted measurement range. The individual sensor units are wired with the SCSP electronics as described with respect to the first option (FIG. 23).

As long as the object to monitor (in this case the piston head) is symmetrically shaped, the object to be monitored can rotate freely at any speed without affecting the sensor performance. When using more than one sensor units to cover the targeted measurement range, the required wiring prohibits that the sensor units can rotate as well. While it is possible to used a telemetric solution that will allow that the sensor units can rotate as well (assuming that the outer cylinder may rotate), in the here described solution it is always assumed that the sensor units are static and do not move or do not rotate.

The differential inductive position sensor solution can be used also to cover only a very specific/limited measurement range. For example, it may be of interest to the user to have an accurate piston head position measurement only when the piston head is reaching or is near the end-position of the piston stroke. To detect the Piston stroke end-position, only one sensor unit may be required.

According to an embodiment of the invention the sensor unit 20 comprises at least two magnetic field detectors 40, 41, 42 to form a compensated gain type, as can be seen in FIG. 16. Thus the sensitivity of the device may be increased by using a differential effect of the detectors. The use of two detectors 41,42 may also provide information on the direction of movement of the object. It should be noted that also each of the two detectors may be of the gain compensation type. Further, the detectors 40, 41, 42 may be provided adjacent to a magnetic field generating element 30, as can be seen in FIG. 17. However, the magnetic field generating element 30 may also surround the detectors 40, 41, 42, as can be seen in FIG. 18. According to an embodiment of the invention the sensor unit comprises at least three magnetic field detectors 40, 41, 42, 43 being arranged in a compensated gain type, as can be seen in FIG. 19. This embodiment may also be provided with a magnetic field generating element 30 according to an arrangement of FIGS. 17 and 18.

The provision of a third detector may give information not only on the direction, but also on some indifferent states being present in the two detector arrangement.

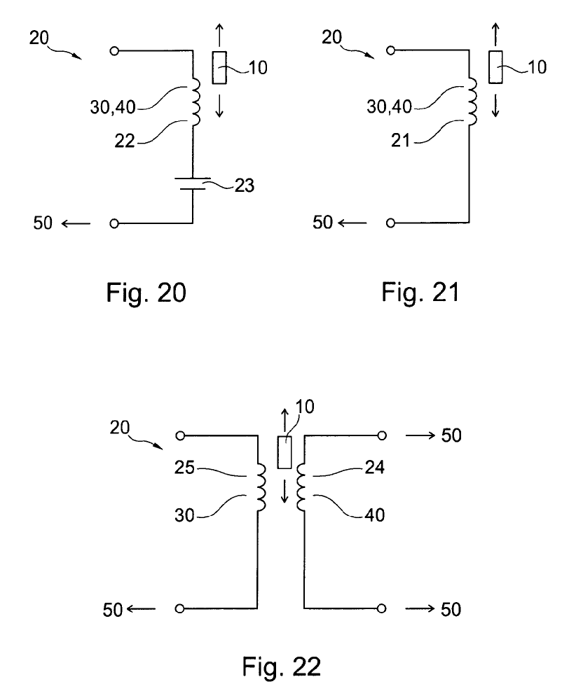

According to an embodiment of the invention the sensor unit comprises a first coil 22 serving as the magnetic field generator 30 as well as the magnetic field detector 40, as can be seen in FIG. 20. The first coil 21 may be part of a oscillating circuit. The oscillation circuit may comprise a coil 22 and a capacitor 23, wherein the processing logic is adapted to measure a frequency or amplitude of the oscillation circuit 22, 23. Thus, the frequency may serve as a parameter on the position of the object. The amplitude may also serve as an parameter when maintaining the resonance frequency. In other words the arrangement may serve as a oscillation circuit, the tuning thereof may serve as parameter on the position of the object.

According to a further embodiment of the invention the sensor unit 20 comprises a first coil 21 forming the magnetic field generator 30 as well as the magnetic field detector 40, wherein the processing logic 50 is adapted to measure a power consumption of the first coil 21, as can be seen in FIG. 21. The changes in the impedance of a coils may serve as a base for a position detection. The sensor device may be calibrated by determining well defined positions and to store the results in a look up table. The sensor device may also be adapted to self calibrate during operation, when for example one sensor unit detects a minimum distance and the distance between two sensor units is known. The power consumption changes when changing the impedance of the coil. Narrowing an impedance influencing material to for example a coil will change its impedance and therefore its power consumption.

According to an embodiment of the invention the sensor unit 20 comprises a first coil 24 serving as the magnetic field detector 40 and a second coil 25 serving as the magnetic field generator 30, wherein the processing logic 50 is adapted to measure a power transmission from the first coil 24 to the second coil 25. Thus, the arrangement may work like a transformer or transducer. The quality of transmission from the first to the second coil or vice versa thus may serve as a base for determining the distance and position of the object.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1-37. (canceled)

38. A sensor device for measuring a position of an object which is made of an inductivity influencing material, comprising:
a sensor unit including a magnetic field generator and a magnetic field detector, the magnetic field detector detecting a magnetic field generated by the magnetic field generator; and
a processing logic arrangement processing signals from the magnetic field detector to determine the position of the object,
wherein the object is movable with respect to the magnetic field generator.

39. The sensor device of claim 38, wherein the sensor unit includes a first coil forming the magnetic field generator and the magnetic field detector, the processing logic arrangement measuring a power consumption of the first coil.

40. The sensor device of claim 38, wherein the sensor unit includes a first coil forming the magnetic field generator and the magnetic field detector, the first coil being part of an oscillating circuit, the processing logic arrangement measuring one of a frequency and an amplitude of the oscillation circuit.

41. The sensor device of claim 38, wherein the sensor unit includes a first coil forming the magnetic field detector and a second coil forming the magnetic field generator, the processing logic arrangement measuring a power transmission from the first coil to the second coil.

42. A piston cylinder arrangement, comprising: and
a cylinder;
a piston being movably arranged within the cylinder;
at least one sensor device including a sensor unit and a processing logic arrangement, the sensor unit including a magnetic field generator and a magnetic field detector, the magnetic field detector detecting a magnetic field generated by the magnetic field generator; the processing logic arrangement processing signals from the magnetic field detector to determine a position of an object,
wherein the piston includes at least a portion which forms the object and wherein the magnetic field detector is arranged on the cylinder.

43. The piston cylinder arrangement of claim 42, wherein the sensor device includes at least two sensor units, measurement ranges of the at least two sensor units one abut and overlap to each other.

44. A sensor device for measuring a property of an object which made of a magnetizable material and having a portion with a varying geometrical shape along a longitudinal axis of the object, comprising:
a magnetic field generator generating a magnetic field in the object; and
at least one magnetic field detector arranged in a vicinity of the portion of the object with the varying geometrical shape to detect at least one detection signal in response to the magnetic field generated in the object,
wherein the at least one detection signal is indicative of the property of the object.

45. The sensor device of claim 44, wherein two magnetic field detectors are arranged around a cylindrical shaft and arranged with respect to one another with an angular offset which differs from essentially 180°.

46. The sensor device of claim 44, wherein two magnetic field detectors are arranged around a cylindrical shaft and arranged with respect to one another with an angular offset which differs from essentially 180° with an angular offset of essentially 90°.

47. The sensor device of claim 44, wherein one of a direct electric signal and an alternating electric signal is applicable to the magnetic field generator to generate the magnetic field in the object with an amplitude of less or equal 30 Gauss.

48. The sensor device of claim 44, further comprising:
a determination unit determining at least one parameter indicative of the property of the object based on the at least one detection signal.

49. The sensor device of claim 44, wherein the at least one magnetic field detector includes at least one of the group consisting of: a coil having a coil axis oriented essentially parallel to the longitudinal axis of the object; a coil having a coil axis oriented essentially perpendicular to the longitudinal axis of the object; a Hall-effect probe; a Giant Magnetic Resonance magnetic field sensor; and a Magnetic Resonance magnetic field sensor.

50. The sensor device of claim 44, wherein the property of the object is selected from the group consisting of an angular position of the object when being rotated and/or shifted along the longitudinal axis, a longitudinal position of the object when being at least one rotated and shifted along the longitudinal axis, a torque applied to the object, a force applied to the object, a shear force applied to the object, a velocity of the object, an acceleration of the object, and a power of the object.

51. A method for measuring a property of an object made of a magnetizable material and having a portion with a varying geometrical shape along a longitudinal axis of the object, comprising:
generating a magnetic field in the object; and
detecting, in a vicinity of the portion with the varying geometrical shape, at least one detection signal in response to the magnetic field generated in the object,
wherein the at least one detection signal is indicative of the property of the object.

52. A sensor device for measuring a property of an object which made of a magnetized material and having a magnetized portion with a varying geometrical shape along a longitudinal axis of the object, comprising:
at least one magnetic field detector arranged in vicinity of the portion of the object with the varying geometrical shape to detect at least one detection signal in response to the magnetic field generated by the magnetized portion of the object,
wherein the at least one detection signal is indicative of the property of the object.

53. A method for measuring a property of an object made of a magnetized material and having a magnetized portion with a varying geometrical shape along a longitudinal axis of the object, comprising:
detecting, in vicinity of the portion of the object with the varying geometrical shape, at least one detection signal in response to the magnetic field generated by the magnetized portion of the object,
wherein the at least one detection signal is indicative of the property of the object.
